(19) United States
(12) Patent Application Publication
(10) Pub. No.: US 2005/0062285 A1
(43) Pub. Date: Mar. 24, 2005

(54) Hydraulic port weld stud

(75) Inventors: Stephan C. Hobson, Hawthorn Woods, IL (US); Blake C. Hobson, Crystal Lake, IL (US)

Correspondence Address: LEYDIG VOIT & MAYER, LTD, 6815 WEAVER ROAD, SUITE 300, ROCKFORD, IL, 61114-8018, US

(73) Assignee: Image Industries, Inc., Wood Dale, IL (US)

(21) Appl. No.: 10/667,613

(22) Filed: Sep. 22, 2003

(51) Int. Cl. F16L 43/00

(52) U.S. Cl. 285/179

(57) ABSTRACT

A hydraulic port weld stud can be attached to hydraulic or pneumatic apparatus for providing an angled fluid port. The weld stud includes separate stud components for providing the two threaded ports of the stud, such that the ports are not formed from the same unitary block of material. The weld boss portion of the weld stud may be integrally formed and unitary with the fitting mount portion to form a one-piece component such that the weld boss does not need to be assembled or brazed on. The block which provides one threaded port such as the female threaded port also provides the weld boss portion and may be generally cylindrical and made of cylindrical stock material. The two primary components of the weld stud are brazed together with a weld ring which provides an indication of proper assembly when melted.

### FIELD OF THE INVENTION

The present invention generally relates to weldable studs and more particularly to hydraulic port weld studs, which may be used to provide an external port fitting connection for hydraulic cylinders or other hydraulic or pneumatic apparatus.

### BACKGROUND OF THE INVENTION

Hydraulic port weld studs or studs with weldable hydraulic ports allow for quicker stronger welds onto hydraulic cylinders (or other hydraulic or pneumatic apparatus such as hydraulic reservoirs) as compared with the manual welding process. The stud weldable ports are easily welded onto hydraulic cylinders, typically in less than one second. In contrast, manual welding of conventional weld port bosses can require up to a minute or more of manual welding. With conventional weld bosses and after the weld port boss is manually welded, typically an angled port fitting must be mounted to the boss. Accordingly, hydraulic port weld studs provide a dramatic time reduction and help hydraulic cylinder manufacturers increase their productivity while cutting cost.

Stud weldable hydraulic ports also permit a stronger weld with less heat distortion of the cylinder. The weld is structurally stronger because it is a full cross-sectional weld, which reduces failure and leaks. Heat distortion in the cylinder is minimized due to the fast welding time, which prevents heat build up within the cylinder housing. With less cylinder distortion, finishing operations are likewise minimized, which results in an enormous cost savings.

Such hydraulic port weld studs are commercially available from the present assignee, Image Industries, Inc. Heretofore, the conventional method for forming a hydraulic port weld stud includes machining a hydraulic fitting from a rectangular block of steel stock material suitable for welding. The rectangular block will typically be formed or machined with an internally threaded female port extending along a first axis and a male threaded port extending along a second perpendicular axis. The male port is formed by machining and turning down the rectangular block to form the male port and threads for that port. A separate weld boss portion is brazed onto the rectangular block. The weld boss portion may be provided with a drilled hole or otherwise drilled to include a pilot hole. This pilot hole can be used to guide a drill bit for later drilling operations after the weld body is attached to a cylinder. The hydraulic port fitting also typically includes a flux load inset on the flat end face of the weld boss portion to provide for the better creation of an arc to initiate the weld process. Hydraulic port weld studs according to the above description have been commercially available from Image Industries, Inc., and are disclosed in literature available from Image Industries, Inc., entitled “Hydraulic Port Weld Stud” and “Port Welding Process Comparison.”

Once the hydraulic weld port stud is formed it is then typically welded to a cylinder, which is the most common application for these weld studs. According to a preferred implementation of such prior art studs as described in the “Port Welding Process Comparison” of Image Industries, Inc., first, a hydraulic cylinder tube is honed without any weldments attached thereto. Thereafter, the weld port stud is welded to the outer cylindrical surface of the hydraulic cylinder with a port stud-welding tool. During this process, the metal material on the weld boss portion melts and integrally attaches with the outer metal surface on the hydraulic cylinder. Thereafter, a drill is inserted into the stud body typically through the female port hole acting as a pilot or drill guide. The drill forms a through-hole through the weld boss and the outer cylindrical tube of the hydraulic cylinder to provide a passageway connecting the inside of the hydraulic cylinder with the passageway extending through the hydraulic weld stud. Thereafter, typically one of the threaded ports on the hydraulic port weld stud is plugged (although it can also serve as an air bleed port if desired).

Although hydraulic port weld studs have provided for significant advancements over manual welding processes and have allowed for quicker and stronger welds of hydraulic port fittings to hydraulic cylinders, there are disadvantages that the present invention remedies such as providing a less expensive, more economical hydraulic weld port fitting, as will be appreciated by one of ordinary skill in the art, once the present invention is understood.

### BRIEF SUMMARY OF THE INVENTION

The present invention is directed toward a hydraulic port weld stud that may be used for hydraulic or pneumatic applications that provides significant advantages over the prior art. There are several separate aspects of the invention which are sought to be protected herein by way of the appended claims hereto. One aspect is directed toward separate stud components for providing the two threaded ports, such that the two ports are not formed from the same unitary block of material. According to this aspect, separate pieces are assembled together to provide the two different ports. In this regard, the weld boss portion may be integrally formed and unitary with a fitting mount portion to form one unitary structural piece, such that the weld boss does not need to be assembled or brazed onto the block portion that typically provides a female threaded port.

Another aspect of the present invention is directed toward the provision of a cylindrical surface on the outer periphery of the weld stud body such that the weld boss portion and fitting mount portion of the mounting body can be unitarily formed with each other from cylindrical stock material, rather than rectangular block stock material. This reduces the amount of material used, reduces the necessary machining to create the various ports and thereby reduces overall manufacturing cost and time for manufacture.

Another aspect of the present invention is that the weld stud body which typically provides a female port and the fitting that provides the male or female port are press fit together with a captive braze ring therebetween that provides a visual indication surrounding the periphery of the threaded male portion that indicates that the two parts have been sealed together to prevent leakage of fluid therebetween. A bore may be formed in the weld stud body to receive the threaded male port fitting.

Other aspects, objectives and advantages of the invention will become more apparent from the following detailed description when taken in conjunction with the accompanying drawings.

### BRIEF DESCRIPTION OF THE DRAWINGS

FIG. 1 is an isometric view of a hydraulic port weld stud in accordance with an embodiment of the present invention.

FIGS. 2-7, in sequence, are side elevation and cross sectional views that illustrate the steps for making the hydraulic port weld stud shown in FIG. 1, with FIG. 7 showing a cross sectional view of the completed hydraulic port weld stud.

FIGS. 8-11 are cross-sectional views of the hydraulic port weld stud being secured to a hydraulic cylinder housing with the steps being shown in sequence in FIGS. 8-11.

FIG. 12 is an isometric view of a hydraulic cylinder having two hydraulic port weld studs secured thereto, in accordance with an embodiment of the present invention.

### DETAILED DESCRIPTION OF THE INVENTION

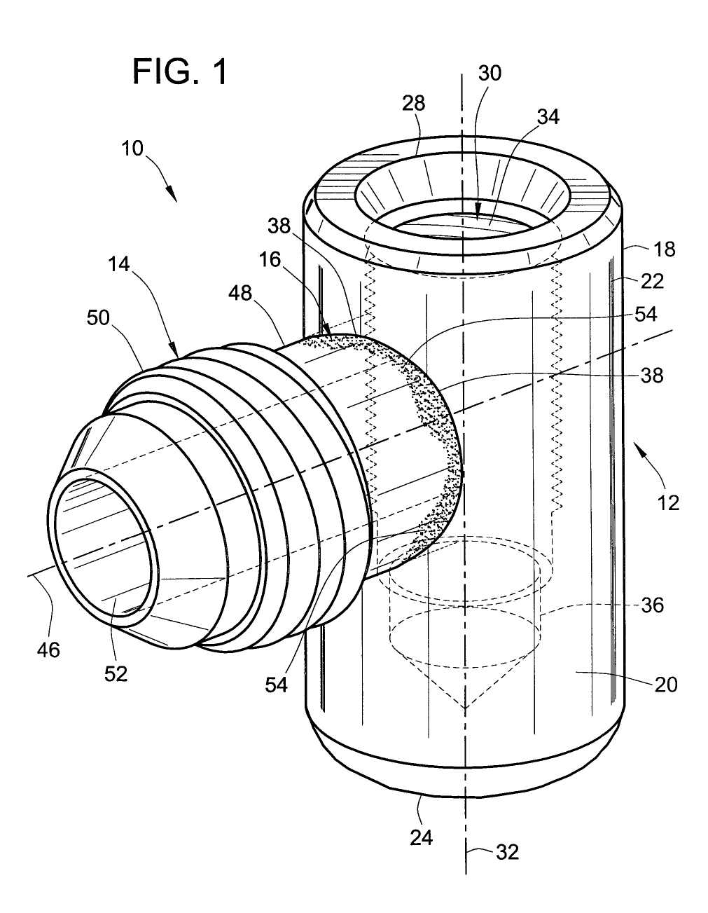

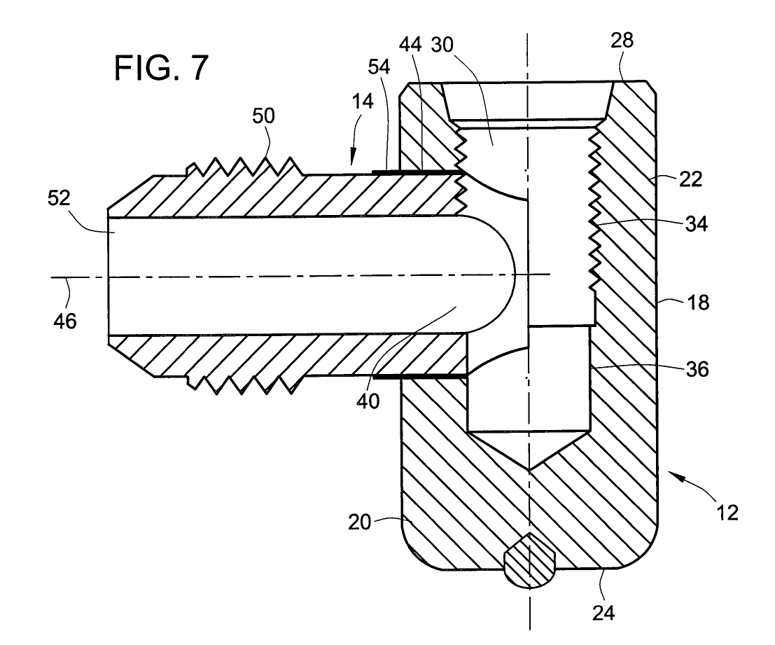

Referring to FIGS. 1 and 7, a hydraulic port weld stud 10 is shown in accordance with a preferred embodiment of the present invention. As shown generally in the figures, the weld stud 10 comprises two primary structural components including a cylindrical mounting body 12 and a cylindrical threaded port fitting 14. These two primary structural components are assembled together via brazing utilizing an intermediate copper braze ring 16 as illustrated.

In accordance with the present invention, the cylindrical mounting body 12 includes or defines an outer cylindrical surface 18. This is of significance because the mounting body 12 may be made from cylindrical rod/wire stock material of a suitable metal for welding purposes. The cylindrical stock is more easily turned down or machined or headed to provide port threading, thereby reducing manufacturing time and cost, as well as potentially reducing waste material and therefore cost. In fact, as shown in the figures, the outer cylindrical surface 18 can be left unfinished (e.g. not machined), and thereby be the unfinished outer peripheral surface of rod stock material. The mounting body 12 can be a single unitary machined piece of the rod/wire stock material that integrally provides a weld boss 20 and a fitting mount portion 22.

The weld boss portion 20 is adapted to be placed on the outer cylindrical surface of a hydraulic cylinder tube for welding thereto. Accordingly, the weld boss portion defines a generally planar weld face 24 at one end of the mounting body 12 that is adapted to be placed against a hydraulic cylinder tube. A flux load tab 26 may be pressed into the planar weld face 24 to project therefrom to provide a structure that is useful for starting an arc during welding operations. Although the weld boss portion 20 and fitting mount portion 22 share common outer diameters, the weld boss portion 20 may also be machined to be of a somewhat reduced diameter (not shown) than the outer cylindrical surface 18 of the fitting mount portion 22, if desired, to provide a smaller welding face.

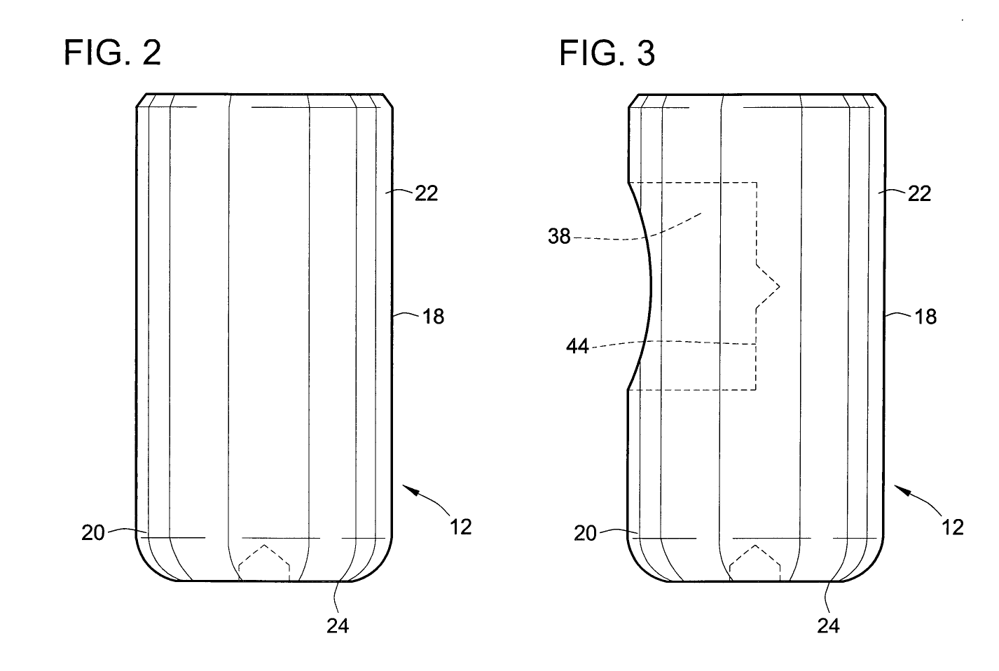

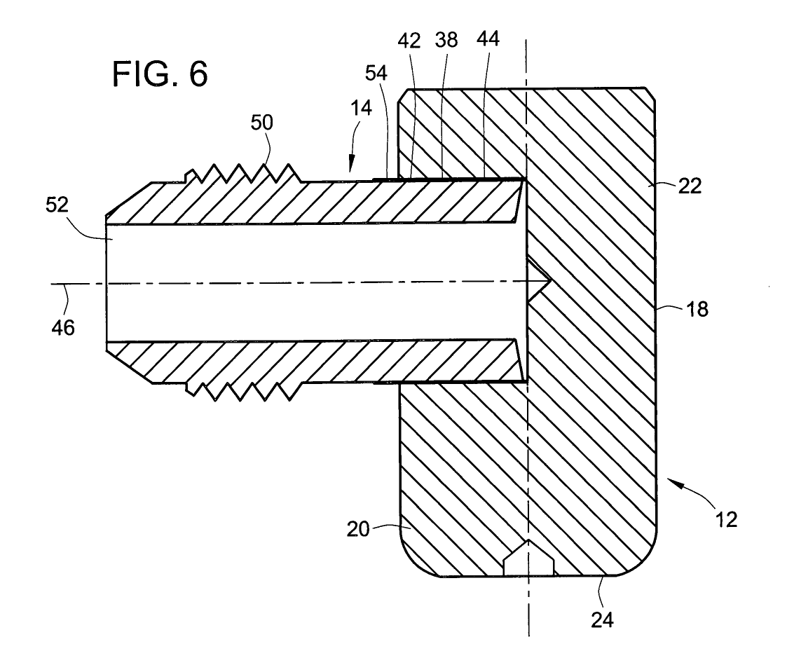

The fitting mount portion 22 is unitary with and adjacent the weld boss portion 20 and includes an open end 28 at the end opposite the planar weld face 24 in which is formed a cylindrical cavity 30 that extends throughout the fitting mount portion 22. With the illustrated steps for making the weld stud shown in FIGS. 2-6, it can also be seen the that the cylindrical cavity 30 also extends through insert end of the cylindrical threaded port fitting 14. The cylindrical cavity 32 is generally concentric about a welding axis 32 and may include a threaded portion 34 and a pilot portion 36. The threaded portion 34 may primarily reside in the fitting mount portion 22 and provides a means for receiving a plug to close off this opening, a bleed valve, or can provide a second port.

The pilot portion 36 may be used to receive and guide a drill bit after the weld stud 10 has been secured to a hydraulic cylinder, when it is desired to drill through the remainder of the weld boss portion 20 and the cylindrical tube of the hydraulic cylinder to provide a fluid passageway therethrough.

As shown herein, the threaded portion 34 is a female type port, which is a preferred implementation of the present invention for the purposes of plugging. However, it will be readily appreciated by one skilled in the art, that the threaded portion 34 may also be of the male portion type with an externally threaded portion projecting axially at the end of the cylindrical mounting body 12.

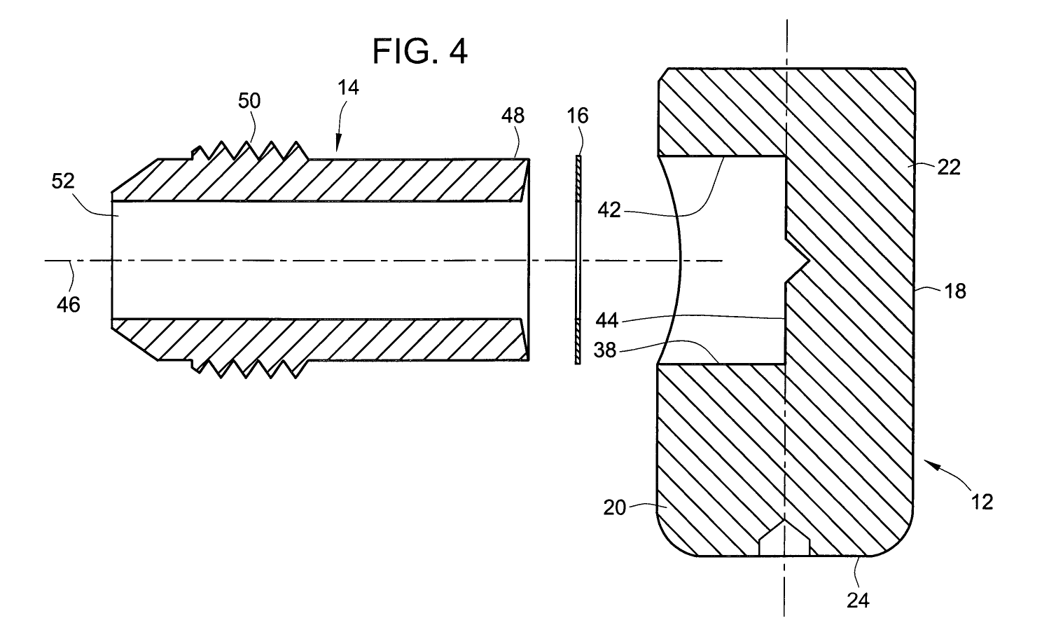

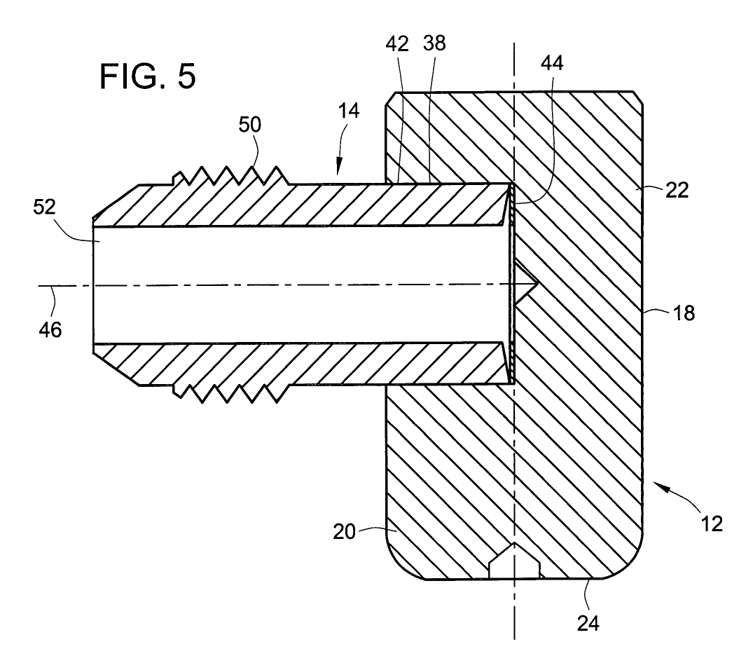

The cylindrical mounting body 12 also includes a formed bore 28 extending through a side of the fitting mount portion 22 and only partly through the fitting mount portion 28. As shown in FIG. 3, during manufacture of the mounting body 12, this bore 28 may be drilled prior to the drilling and tapping of cylindrical cavity 30 to provide a bottom seating surface 44 that provides a seat or stop for positioning the threaded port fitting 14 relative to the mounting body 12. The bore 38 generally extends along a transverse axis 46 that is transverse to the welding axis 32 and in the case of a right angle fitting, there is a perpendicular angle between these two axes (although the axis may be formed at acute or obtuse angles depending on the specific requirements for the fitting). The outer diameter 42 of the bore 38 is closely sized to the cylindrical press fit surface portion 48 of the threaded port fitting 14 such that the threaded port fitting 14 may be press fit into the bore 38 as may be seen in comparing FIGS. 4 and 5. The threaded port fitting 14 also includes male external threads 50 to provide for a port connection (although these threads could similarly be female internal threads, if a female port is desired). The threaded port fitting 14 defines a central transverse passageway 52 that extends through opposed axial ends of the threaded port fitting and communicates with the cylindrical cavity 30 that extends in the mounting body 12.

As mentioned above, the weld stud mounting body 12 and the threaded port fitting 14 are preferably press fit together. To provide a seal therebetween, the braze ring 16 is inserted into the bore 38 and against the hole bottom 44 during assembly. Once this is accomplished as shown in FIG. 5, the assembly is heated, melting the braze ring 16 which integrally secures the mounting body 12 and the threaded port fitting 14 together. In addition, melted braze ring 16 material seeps between corresponding cylindrical press fit surfaces and forms an exposed ring surface 54 of a different color or character than the color or character of the material used for the threaded port fitting 14 and thereby provides a means for indicating that a complete seal has been formed between the mounting body 12 and the threaded port fitting 14. One can readily examine to make sure that this ring surface 54 is continuous to ensure that there are no gaps or breaks in the exposed ring surface 54 formed from the melted braze ring 16, and thereby ensure that a seal has been properly formed. Such a reliable indicating means has not been provided by the prior art as the braze joint in prior art weld stud bodies are disposed at a completely different location.

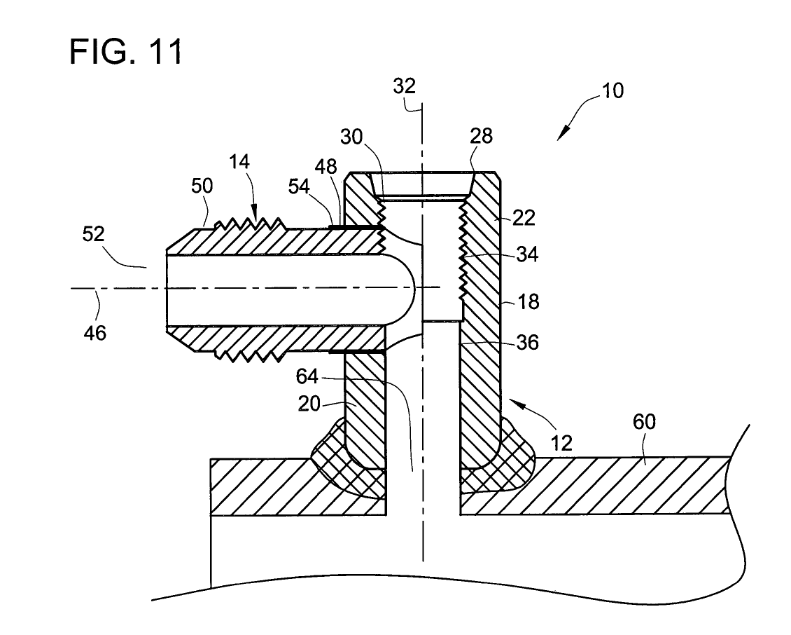

Once the mounting body 12 and the threaded port fitting 14 are secured together, the cylindrical cavity 30 can be formed through the mounting body 12 and the inserted end of the threaded port fitting 14. This connects the trasverse passageway 52 with the cylindrical cavity 30, which forms part of the passageway once assembled in an application as shown in FIG. 11.

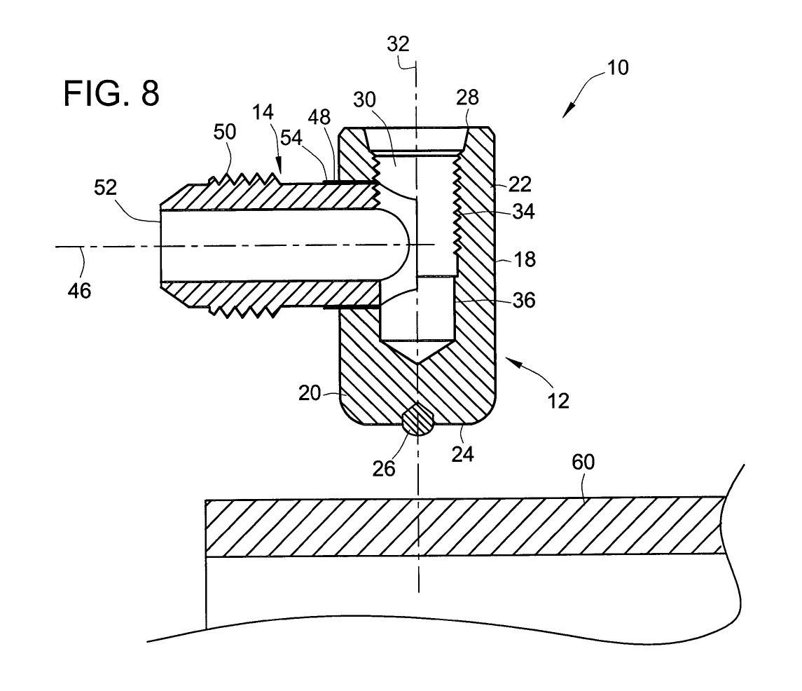

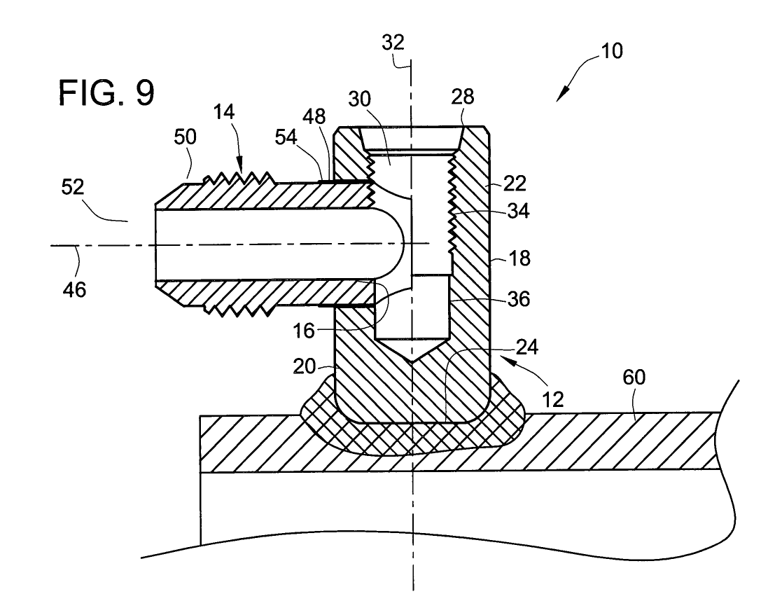

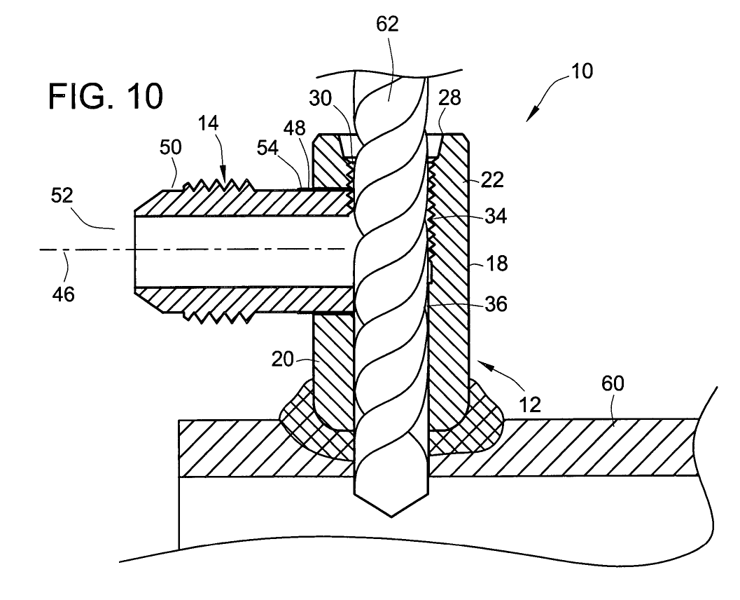

Turning to FIGS. 8-11, an assembly process for securing the weld stud 10 onto a hydraulic cylinder tube 60 is illustrated. As shown therein, the hydraulic port weld stud 10 is first integrally welded onto the hydraulic cylinder tube 60 typically proximate with one of the ends of the hydraulic cylinders. This is accomplished with a port stud welding tool (not shown). During this procedure, and as shown in FIG. 7, the planar weld face 24 is placed against the outer peripheral surface of the hydraulic cylinder tube 60 and an arc is developed that integrally melts the material and effectively welds the two components together. This can typically be done in less than about one second. After that, and referring to FIG. 9, a drill bit 62 is inserted through the cylindrical cavity 30 and is guided by the pilot portion 36 to drill through the solid portion of the weld boss portion 20 and through the hydraulic cylinder tube 60 to extend the cylindrical cavity 30 through the weld boss portion 20 and thereby provide a passageway 64 connecting the inside of the weld stud 10 to the inside of the hydraulic cylinder tube 60, as is shown in FIGS. 10-12.

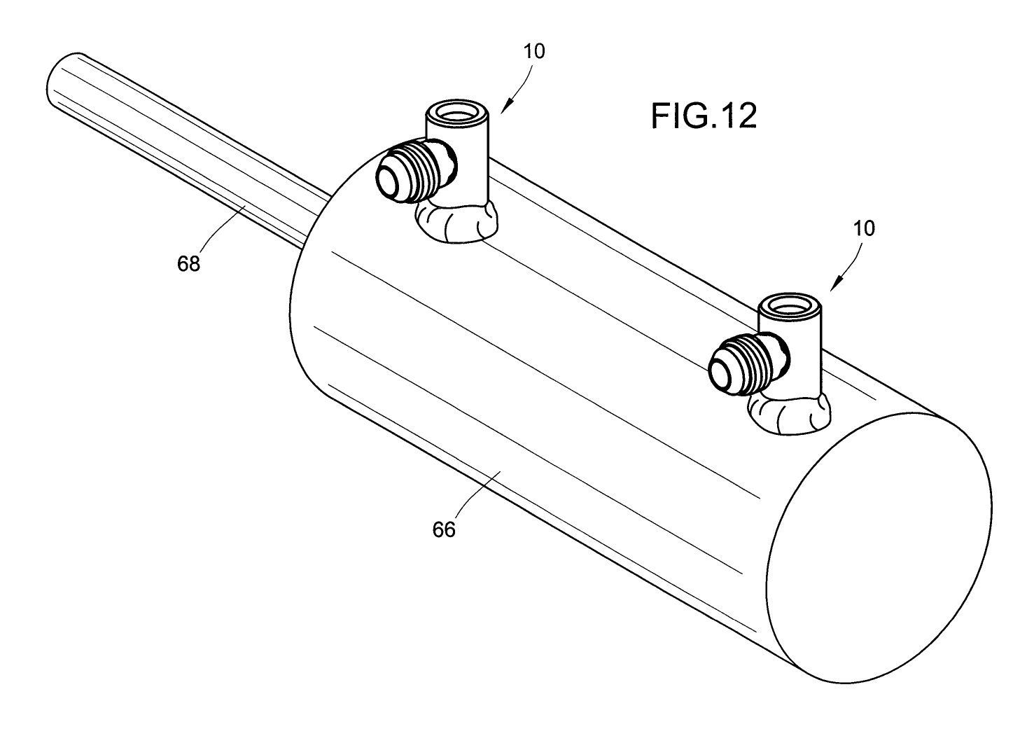

FIG. 12 shows a completed hydraulic cylinder 66 including the hydraulic cylinder tube 60, a piston 68 slidable therein and two weld studs 10 mounted on opposed axial ends of the hydraulic cylinder 66.

A further advantage of the disclosed embodiment is that one directional hydraulic port weld studs (that extend only along one axis) which are used for other applications can be used to create the right angle or different direction angle weld stud 10 of the present invention. Thus, the component of the threaded port fitting 14 cannot only be used in making the present invention, but can be used as an off the shelf component for applications where a right angle or a transverse angle for a port is not necessary.

A further advantage realized in the present invention is that assembly tolerances are eliminated in the vertical or welding axis 32 dimension. This is accomplished because the mounting body 12 is a unitary one-piece member and does not have a braze joint between two separate portions as per prior art devices, which creates a small error or increases the tolerance. This substantially reduces tolerances in the vertical or welding axis 32 dimension in the completed stud 10, which allows cylinder manufacturers to more precisely and accurately locate the weld stub on the cylinder tube at the desired location. This tolerance can be critical in certain applications. Instead of assembly tolerances in the vertical dimension, the braze joint tolerances have been moved to the horizontal or transverse axis dimension 46 which are not considered as critical or as important as the tolerances in the vertical dimension.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A hydraulic port weld stud, comprising:
a weld stud mounting body extending along a first axis, the mounting body including a weld boss portion and a fitting mount portion;
a cylindrical surface concentric about the first axis defined over an outer periphery the fitting mount portion;
a cylindrical cavity concentric about the first axis in the fitting mount portion;
a port fitting integral with the fitting mount portion of the weld stud body, extending along a second axis transverse to the first axis; and
a hydraulic port passage extending through the port fitting in fluid communication with the cylindrical cavity.

2. The hydraulic port weld stud of claim 1, wherein the weld stud mounting body defines a bore coaxial about the second axis, further comprising a melted braze ring in the bore integrally securing the port fitting as a separately formed component to the mounting body.

3. The hydraulic port weld stud of claim 2, wherein the melted braze ring provides a visual indication ring means for indicating a seal surrounding an outer periphery of the port fitting.

4. The hydraulic port weld stud of claim 1, wherein the mounting body is formed from a cylindrical stock material, wherein said cylindrical surface is an unfinished cylindrical surface of the cylindrical stock material.

5. A hydraulic port weld stud, comprising:
a mounting body extending along a first axis, the mounting body including a cylindrical weld boss portion and a cylindrical fitting mount portion, the cylindrical weld boss portion and the cylindrical fitting mount portion being unitarily formed as a single structural component;
a cylindrical surface concentric about the first axis, the cylindrical surface defined over an outer periphery of the fitting mount portion;
a cylindrical cavity concentric about the first axis formed in the fitting mount portion, the cylindrical cavity comprising a threaded portion and a non-threaded pilot portion, the non-threaded pilot portion extending partially through the cylindrical weld boss portion and being of a smaller diameter than the threaded portion;
a bore formed into the cylindrical fitting mount portion along an second axis transverse to the first axis;
a cylindrical threaded port fitting formed separately from the mounting body, the threaded port fitting being inserted into the bore and projecting axially therefrom along the second axis, the threaded port fitting defining a central passageway connected to the cylindrical cavity; and
a melted braze ring in the bore integrally securing the threaded port fitting to the mounting body.

6. The hydraulic port weld stud of claim 5, wherein the mounting body is formed from a cylindrical stock material, wherein said cylindrical surface is an unfinished cylindrical surface of the cylindrical stock material.

7. The hydraulic port weld stud of claim 6, wherein the cylindrical weld boss portion has an outer cylindrical periphery that is of a smaller diameter than said cylindrical surface.

8. The hydraulic port weld stud of claim 5, wherein the melted braze ring provides a visual indication ring means for indicating a seal surrounding an outer periphery of the threaded port fitting.

9. The hydraulic port weld stud of claim 5, wherein said threaded portion comprises female threads defined in said cylindrical cavity.

10. The hydraulic port weld stud of claim 5, wherein the cylindrical weld boss portion includes a planar welding face, further comprising a flux load insert secured to the cylindrical boss portion and projecting from a center of the planar welding face.

11. The hydraulic port weld stud of claim 5, wherein the second axis is perpendicular to the first axis.

12. A hydraulic port weld stud, comprising:
a mounting body extending along a first axis, the mounting body including a weld boss portion and a fitting mount portion, the weld boss portion and the fitting mount portion being unitarily formed as a single structural component;
a cylindrical cavity concentric about the first axis formed through the fitting mount portion;
a bore in the fitting mount portion extending along a second axis, the second axis being transverse to the first axis;
a threaded port fitting formed separately from the mounting body, the threaded port fitting being inserted into the bore and projecting axially therefrom along the second axis, the threaded port fitting defining a central passageway connected to the cylindrical cavity; and
a melted braze ring in the bore integrally securing the threaded port fitting to the mounting body.

13. The hydraulic port weld stud of claim 12, wherein the melted braze ring provides a visual indication ring means for indicating a seal surrounding an outer periphery of the threaded port fitting.

14. The hydraulic port weld stud of claim 12, further comprising a cylindrical surface concentric about the first axis defined over an outer periphery of the fitting mount portion.

15. The hydraulic port weld stud of claim 12, further comprising a flux load inset secured to the mounting body.

16. The hydraulic weld port stud of claim 12, wherein the cylindrical cavity extends through an end of the threaded port fitting.

17. In combination, a hydraulic port weld stud and a hydraulic cylinder, the combination comprising:
the hydraulic cylinder comprising:
(a) a cylinder housing defining a piston chamber; and
(b) a piston linearly reciprocating within the piston chamber of the cylinder housing dividing the piston chamber into separate fluid chambers;
the hydraulic port weld stud mounted to cylinder proximate at least one end in fluid communication with one of the separate fluid chambers, the hydraulic port weld stud comprising:
(a) a mounting body extending along a first axis, the mounting body including a cylindrical weld boss portion welded to the cylinder housing and a cylindrical fitting mount portion;
(b) a cylindrical surface concentric about the first axis, the cylindrical surface defined over an outer periphery of the fitting mount portion;
(c) a cylindrical cavity concentric about the first axis formed through the fitting mount portion, the cylindrical cavity extending through the cylindrical weld boss portion and the cylinder housing to provide a fluid passageway extending from said one of the separate fluid chambers through the cylinder housing and the hydraulic port weld stud;
(d) a bore formed into the cylindrical fitting mount portion along a second axis transverse to the first axis;
(e) a cylindrical threaded port fitting formed separately from the mounting body, the threaded port fitting being inserted into the bore and projecting axially therefrom along the second axis, the threaded port fitting defining a central passageway connected to the cylindrical cavity; and
(f) a melted braze ring in the bore integrally securing the threaded port fitting to the mounting body.

18. The combination of claim 17, further comprising a plug mounted to the fitting mount portion enclosing an end of the cylindrical cavity.

19. The hydraulic port weld stud of claim 17, wherein the melted braze ring provides a visual indication ring means for indicating a seal surrounding an outer periphery of the threaded port fitting.

20. The hydraulic port weld stud of claim 17, wherein at least two of the hydraulic port weld studs are provided on the hydraulic cylinder, one for each of said separate fluid chambers.
